(19) United States
(12) Patent Application Publication
(10) Pub. No.: US 2005/0053530 A1
(43) Pub. Date: Mar. 10, 2005

(54) Electronic device having air purifying function

(76) Inventor: Ko Lee Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/657,265

(22) Filed: Sep. 9, 2003

(51) Int. Cl. B01J 19/08

(52) U.S. Cl. 422/186.15; 422/186.07

(57) ABSTRACT

An electronic device, which can be an AC adapter, mobile telephone hand-free handset, or mobile telephone battery charger is disclosed having a plurality of air outlets in the outer shell thereof and an ozone (O₃)/anion (H₃0₂⁻) generating circuit adapted to generate ozone and anion and output generated ozone and anion through the air outlet to purify air after connection of the electronic device to power supply.

### BACKGROUND OF THE INVENTION

1. Field of the Invention

The present invention relates to mobile electronic devices and, more particularly, to such electronic device that has the function of purifying air.

2. Description of the Related Art

Various air cleaners/purifiers have been disclosed, and have appeared on the market. These devices commonly use an ozone or anion generator to generate ozone or anion for purifying air. When an air cleaner or purifier is used in a house or automobile, it requires much installation space. Further, various mobile electronic devices such as AC adapters, stereo systems, LCDs, printers, modems, battery chargers, etc. may be used and maintained connected to electric outlets constantly. These electronic devices do not provide any added function when connected to power supply.

### SUMMARY OF THE INVENTION

The present invention has been accomplished under the circumstances in view. It is the main object of the present invention to provide an electronic device, which provides the added function of purifying air. It is another object of the present invention to add an air purifying function to an electronic device without increasing the installation space of the electronic device. According to one aspect of the present invention, the electronic device comprises a plurality of air outlets in the outer shell thereof, and an ozone (O₃)/anion (H₃0₂⁻) generating circuit adapted to generate ozone and anion and output generated ozone and anion through the air outlet to purify air after connection of the electronic device to power supply. According to another aspect of the present invention, the electronic device can be an AC adapter, mobile telephone hand-free handset, or mobile telephone battery charger.

### BRIEF DESCRIPTION OF THE DRAWINGS

FIG. 1 is an elevational view of an AC adapter according to the present invention.

FIG. 2 is a circuit diagram of the present invention.

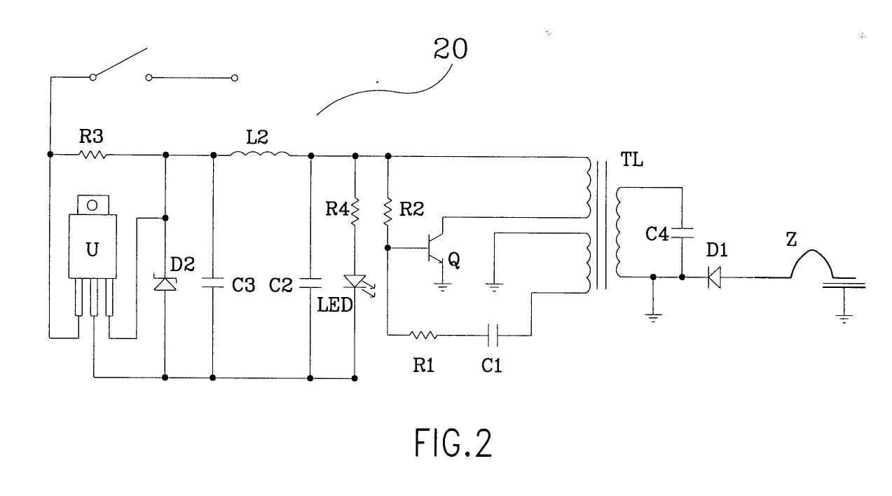

FIG. 3 is an elevational view of another design of AC adapter according to the present invention.

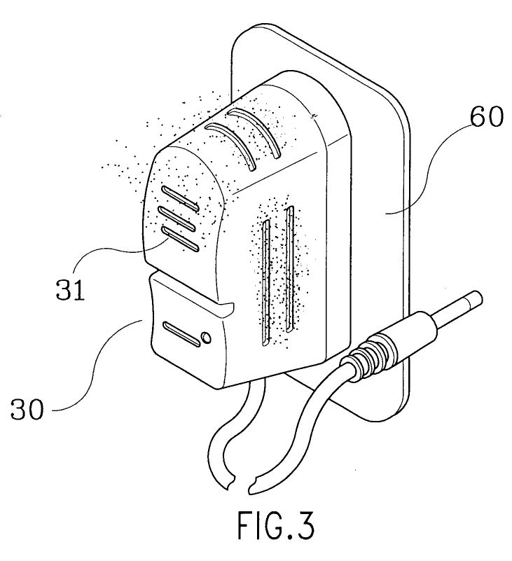

FIG. 4 is an elevational view of a mobile telephone charger according to the present invention.

FIG. 5 is an elevational view a mobile telephone hand-free handset according to the present invention.

### DETAILED DESCRIPTION OF THE PREFERRED EMBODIMENT

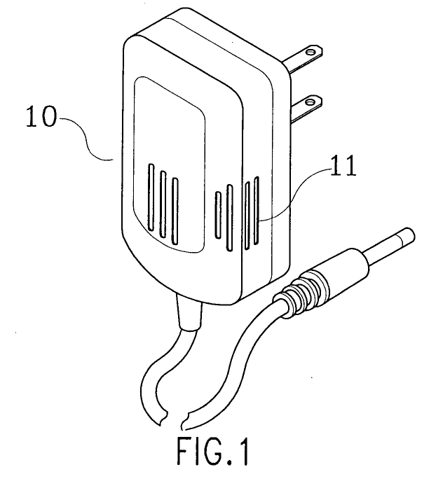

Referring to FIGS. 1˜3, an AC adapter 10 or 30 is shown having a plurality of air outlets 11 or 31 in the outer shell thereof and an ozone (O₃)/anion (H₃0₂⁻) generating circuit 20. After insertion of the AC adapter 10 or 30 into an electric outlet 60, the ozone (O₃)/anion (H₃0₂⁻) generating circuit 20 is started to generate ozone (O₃) and anion H₃0₂⁻, enabling generated ozone (O₃) and anion (H₃0₂⁻) to pass out of the air outlets 11 and to further purify the air inside the house and remove bad smell from the air.

Referring to FIGS. 1˜3 again, the ozone (O₃)/anion H₃0₂⁻ generating circuit 20 is incorporated into the internal circuit of the AC adapter 10 or 30. When the AC adapter 10 or 30 connected to the electric outlet 30, input power is rectified by a rectifier IC U into a stabilized voltage, which is ten processed into a high voltage by a transistor Q and a transformer TL, and then discharged through a discharging circuit formed of discharging spring means Z and mica means, thereby causing an air sterilizing gas of about 70% anion (H₃0₂⁻) and 30% ozone (O₃) to be produced. Anion H₃0₂⁻ attracts onion, dust, micro particles and impurities in air, thereby causing air to be purified. Ozone O₃) kills germs in air and removes bad smell from air, keeping air refreshed.

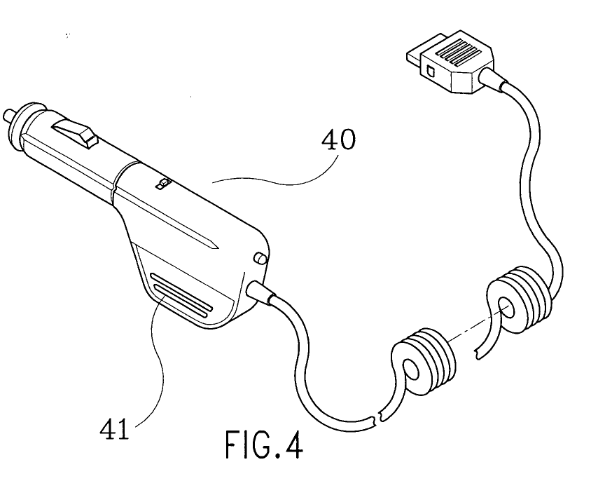

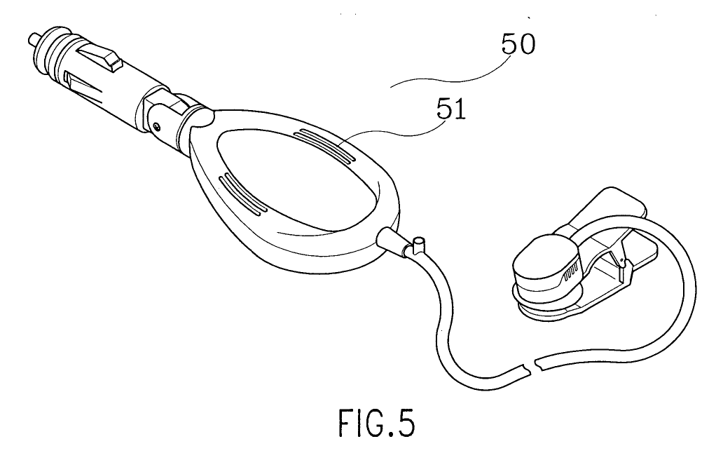

FIGS. 4 and 5 show a mobile telephone charger 40 for motor vehicle and a mobile telephone hand-free handset 50 constructed according to the present invention, the mobile telephone charger 40 and the mobile telephone hand-free set 50 each have a plurality of air outlets 41 or 51 and an ozone (O₃)/anion (H₃0₂⁻) generating circuit (not shown) on the inside. After connection of the mobile telephone charger 40 or mobile telephone hand-free set 50 to the electric socket for cigarette lighter inside a motor vehicle, the ozone (O₃)/anion (H₃0₂⁻) generating circuit of the mobile telephone charger 40 or mobile telephone hand-free set 50 is started to generate ozone (O₃) and anion H₃0₂⁻, enabling generated ozone (O₃) and anion (H₃0₂⁻) to pass out of the air outlets 41 or 51 and to further purify the air inside the motor vehicle and remove bad smell from the air.

As indicated above, any of a variety of electronic apparatus can be made having incorporated therein an ozone (O₃)/anion (H₃0₂⁻) generating circuit for purifying air after connection of the electronic apparatus to power supply.

A prototype of electronic device having air purifying function has been constructed with the features of FIGS. 1˜5. The electronic device having air purifying function functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. An electronic device comprising a plurality of air outlets in an outer shell thereof and an ozone (O₃)/anion (H₃0₂⁻) generating circuit adapted to generate ozone and anion and output generated ozone and anion through said air outlet after connection of the electronic device to power supply.

2. The electronic device as claimed in claim 1, which is an AC adapter.

3. The electronic device as claimed in claim 1, which is a mobile telephone hand-free handset.

4. The electronic device as claimed in claim 1, which is a mobile telephone battery charger for use in a motor vehicle.
